(19) United States
(12) Patent Application Publication
(10) Pub. No.: US 2024/0353818 A1
(43) Pub. Date: Oct. 24, 2024

(54) CONTEXT DISCOVERY SYSTEM AND METHOD

(71) Applicant: Honeywell International Inc., Charlotte, NC (US)

(72) Inventors: Petr STLUKA, Charlotte, NC (US); Jiri VASS, Charlotte, NC (US)

(21) Appl. No.: 18/260,740

(22) PCT Filed: Jan. 12, 2022
(86) PCT No.: PCT/US2022/070154

§ 371 Date: Jul. 7, 2023

Related U.S. Application Data
(60) Provisional application No. 63/137,302, filed on Jan. 14, 2021.

(51) Int. Cl. G05B 19/418

(52) U.S. Cl. CPC G05B 19/4185; G05B 2219/25255

(57) ABSTRACT

Various embodiments described herein relate to efficient and accurate context discovery of an asset system. In this regard, telemetry data comprising a plurality of data points associated with an asset system is received. The telemetry data is then processed in accordance with one or more context discovery operations. Furthermore, based on the processing of the telemetry data, for each context discovery operation, output data is determined comprising one or more mapping structures indicative of a potential mapping for a respective data point of the plurality of data points. The output data is processed, including identifying one or more definitive mappings. Context data is then generated for the asset system comprising the one or more definitive mappings of respective data points.

### TECHNICAL FIELD

The present disclosure relates generally to asset systems, and more particularly to determining contextual information of asset systems.

### BACKGROUND

Various industries include a large amount of assets, such as interconnected devices and/or equipment at one or multiple locations, such as industrial plants and/or buildings. Such industries may benefit from having an associated digital model or representation of the asset system in order to perform analytical operations and/or other processes that may gauge efficiency of the asset system and/or confirm that the asset system is functioning properly. However, an onboarding or generation speed of the digital model may be hindered by approaches used to identify each individual asset and accurately represent each asset to ensure data is matched correctly.

### BRIEF SUMMARY

In accordance with some embodiments, a method is performed. The method includes receiving telemetry data comprising a plurality of data points associated with an asset system. The method also includes processing the telemetry data in accordance with one or more context discovery operations. The method also includes determining, based on the processing of the telemetry data, for each context discovery operation, output data comprising one or more mapping structures indicative of a potential mapping for a respective data point of the plurality of data points. The method also includes processing the output data, the processing identifying one or more definitive mappings. The method also includes generating context data, based on the processing of the output data, for the asset system comprising the one or more definitive mappings of respective data points.

In some embodiments of the method, each data point of the plurality of data points comprises one or more of text data, time-series data, and hierarchical data.

In some embodiments of the method, each mapping structure comprises a confidence value indicative of the confidence of the potential mapping.

In some embodiments of the method, the processing of the output data comprises merging at least a portion of the mapping structures.

In some embodiments of the method, the context data further comprises at least one mapping structure of the one or more mapping structures indicative of the potential mapping for the respective data point of the plurality of data points, the at least one mapping structure being associated with a portion of the mapping structures not having undergone the merging.

In some embodiments, the method also includes determining whether a confidence value associated with a merger of two or more mapping structures exceeds a predefined confidence threshold, and, in accordance with the determination that the confidence value exceeds the predefined confidence threshold, identifying the merger of the two or more mapping structures as a definitive mapping.

In some embodiments of the method, at least one definitive mapping of the one or more definitive mappings is based on a merging of at least a first mapping structure and a second mapping structure, with the first mapping structure having been determined based on processing the telemetry data in accordance with a first context discovery operation and the second mapping structure having been determined based on processing the telemetry data in accordance with a second context discovery operation, different from the first context discovery operation.

In some embodiments of the method, the processing of the telemetry data in accordance with the one or more context discovery operations comprises processing the telemetry data in accordance with one or more token interpretation operations, one or more context translation operations, and one or more neural network operations.

In some embodiments of the method, the processing of the telemetry data in accordance with the one or more token interpretation operations comprises identifying one or more tokens of text data associated with a respective data point of the plurality of data points. The processing of the telemetry data in accordance with the one or more token interpretation operations also comprises determining a mapping structure of at least one token of the one or more tokens to a predefined token of a predefined token set based on at least a portion of the at least one token matching the predefined token. The processing of the telemetry data in accordance with the one or more token interpretation operations also comprises determining a confidence value for the mapping structure based at least on a character length of the portion of the at least one token and a character length of the predefined token.

In some embodiments of the method, the one or more tokens of the text data associated with the respective data point are identified by at least one of splitting the text data based on recurring characters of the text data, splitting the text data based on one or more delimiter characters of the text data, splitting the text data based on one or more alphabetic characters following one or more numerical characters of the text data, and splitting the text data based on one or more numerical characters of the text data.

In some embodiments of the method, the text data associated with the respective data point comprising one or more of a point name of the respective data point, a textual description of the respective data point, a data type of the respective data point, a unit of measure of the respective data point, one or more enumeration labels of the respective data point, one or more defined property names of the respective data point, and one or more tags of the respective data point.

In some embodiments of the method, the processing of the telemetry data in accordance with the one or more context translation operations comprises identifying, for a respective data point, metadata associated with the respective data point. In some embodiments, the processing of the telemetry data in accordance with the one or more context translation operations also comprises processing the metadata in accordance with a context translation rule set, and, based on the processing, determining one or more mapping structures indicative of a potential mapping of a portion of the metadata to one or more predefined assets and a confidence value for the potential mapping.

In some embodiments of the method, the processing of the telemetry data in accordance with the one or more neural network operations comprises identifying, for a respective data point, metadata associated with the respective data point. In some embodiments, the processing of the telemetry data in accordance with the one or more neural network operations also comprises processing the metadata in accordance with one or more models, the one or more models each trained to predict a potential mapping of a particular portion of the metadata of the respective data point. In some embodiments, the processing of the telemetry data in accordance with the one or more neural network operations also comprises determining, based on the processing, one or more mapping structures indicative of a potential mapping of portion of the metadata to one or more predefined assets and a confidence value for the potential mapping.

In some embodiments of the method, the processing of the output data comprises processing the output data in accordance with a point role template set to generate one or more point role mapping structures. In some embodiments, the processing of the output data in accordance with the point role template set comprises determining, for a respective data point and a respective point role template of a point role template set, a point role match confidence value based at least on an identification of a concept term associated with both a mapping structure associated with the respective data point and the respective point role template. In some embodiments, the processing of the output data in accordance with the point role template set also comprises generating, based at least on the point role match confidence value, a point role mapping structure comprising at least an indication of the respective data point and an indication of the respective point role template, with the context data further comprising the one or more point role mapping structures.

In some embodiments, the processing of the output data in accordance with the point role template set also comprises generating a ranked listing of the point role match confidence values, with the point role mapping structure being generated based on having the highest point role match confidence value of the ranked listing of the determined point role match confidence values.

In some embodiments of the method, the processing of the output data comprises generating a ranked list of one or more mapping structures associated with a particular asset in order of respective confidence values. In some embodiments, the processing of the output data also comprises determining, based on the ranked list, an asset type for a respective asset.

In some embodiments, the method also includes causing transmission of the generated context data to a semantic model generation application.

In accordance with some embodiments, a system is provided. The system includes a processor and a memory that stores executable instructions that, when executed by the processor, cause the processor to receive telemetry data comprising a plurality of data points associated with an asset system. The executable instructions, when executed by the processor, also cause the processor to process the telemetry data in accordance with one or more context discovery operations. The executable instructions, when executed by the processor, also cause the processor to determine, based on the processing of the telemetry data, for each context discovery operation, output data comprising one or more mapping structures indicative of a potential mapping for a respective data point of the plurality of data points. The executable instructions, when executed by the processor, also cause the processor to process the output data, the processing identifying one or more definitive mappings. The executable instructions, when executed by the processor, also cause the processor to generate context data, based on the processing of the output data, for the asset system comprising the one or more definitive mappings of respective data points.

In some embodiments of the system, each data point of the plurality of data points comprises one or more of text data, time-series data, and hierarchical data.

In some embodiments of the system, each mapping structure comprises a confidence value indicative of the confidence of the potential mapping.

In some embodiments of the system, the processing of the output data comprises merging at least a portion of the mapping structures.

In some embodiments of the system, the context data further comprises at least one mapping structure of the one or more mapping structures indicative of the potential mapping for the respective data point of the plurality of data points, the at least one mapping structure being associated with a portion of the mapping structures not having undergone the merging.

In some embodiments, the executable instructions, when executed by the processor, also cause the processor to determine whether a confidence value associated with a merger of two or more mapping structures exceeds a predefined confidence threshold, and, in accordance with the determination that the confidence value exceeds the predefined confidence threshold, identify the merger of the two or more mapping structures as a definitive mapping.

In some embodiments of the system, at least one definitive mapping of the one or more definitive mappings is based on a merging of at least a first mapping structure and a second mapping structure, with the first mapping structure having been determined based on processing the telemetry data in accordance with a first context discovery operation and the second mapping structure having been determined based on processing the telemetry data in accordance with a second context discovery operation, different from the first context discovery operation.

In some embodiments of the system, the processing of the telemetry data in accordance with the one or more context discovery operations comprises processing the telemetry data in accordance with one or more token interpretation operations, one or more context translation operations, and one or more neural network operations.

In some embodiments of the system, the processing of the telemetry data in accordance with the one or more token interpretation operations comprises identifying one or more tokens of text data associated with a respective data point of the plurality of data points. The processing of the telemetry data in accordance with the one or more token interpretation operations also comprises determining a mapping structure of at least one token of the one or more tokens to a predefined token of a predefined token set based on at least a portion of the at least one token matching the predefined token. The processing of the telemetry data in accordance with the one or more token interpretation operations also comprises determining a confidence value for the mapping structure based at least on a character length of the portion of the at least one token and a character length of the predefined token.

In some embodiments of the system, the one or more tokens of the text data associated with the respective data point are identified by at least one of splitting the text data based on recurring characters of the text data, splitting the text data based on one or more delimiter characters of the text data, splitting the text data based on one or more alphabetic characters following one or more numerical characters of the text data, and splitting the text data based on one or more numerical characters of the text data.

In some embodiments of the system, the text data associated with the respective data point comprising one or more of a point name of the respective data point, a textual description of the respective data point, a data type of the respective data point, a unit of measure of the respective data point, one or more enumeration labels of the respective data point, one or more defined property names of the respective data point, and one or more tags of the respective data point.

In some embodiments of the system, the processing of the telemetry data in accordance with the one or more context translation operations comprises identifying, for a respective data point, metadata associated with the respective data point. In some embodiments, the processing of the telemetry data in accordance with the one or more context translation operations also comprises processing the metadata in accordance with a context translation rule set, and, based on the processing, determining one or more mapping structures indicative of a potential mapping of a portion of the metadata to one or more predefined assets and a confidence value for the potential mapping.

In some embodiments of the system, the processing of the telemetry data in accordance with the one or more neural network operations comprises identifying, for a respective data point, metadata associated with the respective data point. In some embodiments, the processing of the telemetry data in accordance with the one or more neural network operations also comprises processing the metadata in accordance with one or more models, the one or more models each trained to predict a potential mapping of a particular portion of the metadata of the respective data point. In some embodiments, the processing of the telemetry data in accordance with the one or more neural network operations also comprises determining, based on the processing, one or more mapping structures indicative of a potential mapping of portion of the metadata to one or more predefined assets and a confidence value for the potential mapping.

In some embodiments of the system, the processing of the output data comprises processing the output data in accordance with a point role template set to generate one or more point role mapping structures. In some embodiments, the processing of the output data in accordance with the point role template set comprises determining, for a respective data point and a respective point role template of a point role template set, a point role match confidence value based at least on an identification of a concept term associated with both a mapping structure associated with the respective data point and the respective point role template. In some embodiments, the processing of the output data in accordance with the point role template set also comprises generating, based at least on the point role match confidence value, a point role mapping structure comprising at least an indication of the respective data point and an indication of the respective point role template, with the context data further comprising the one or more point role mapping structures.

In some embodiments of the system, the processing of the output data in accordance with the point role template set also comprises generating a ranked listing of the point role match confidence values, with the point role mapping structure being generated based on having the highest point role match confidence value of the ranked listing of the determined point role match confidence values.

In some embodiments of the system, the processing of the output data comprises generating a ranked list of one or more mapping structures associated with a particular asset in order of respective confidence values. In some embodiments, the processing of the output data also comprises determining, based on the ranked list, an asset type for a respective asset.

In some embodiments, the executable instructions, when executed by the processor, also cause the processor to cause transmission of the generated context data to a semantic model generation application.

In accordance with some embodiments, a non-transitory computer-readable storage medium is provided. The non-transitory computer-readable storage medium includes one or more programs for execution by one or more processors of a first device. The one or more programs include instructions which, when executed by the one or more processors, cause the device to receive telemetry data comprising a plurality of data points associated with an asset system. The one or more programs also include instructions which, when executed by the one or more processors, cause the device to process the telemetry data in accordance with one or more context discovery operations. The one or more programs also include instructions which, when executed by the one or more processors, cause the device to determine, based on the processing of the telemetry data, for each context discovery operation, output data comprising one or more mapping structures indicative of a potential mapping for a respective data point of the plurality of data points. The one or more programs also include instructions which, when executed by the one or more processors, cause the device to process the output data, the processing identifying one or more definitive mappings. The one or more programs also include instructions which, when executed by the one or more processors, cause the device to generate context data, based on the processing of the output data, for the asset system comprising the one or more definitive mappings of respective data points.

In some embodiments of the non-transitory computer-readable storage medium, each data point of the plurality of data points comprises one or more of text data, time-series data, and hierarchical data.

In some embodiments of the non-transitory computer-readable storage medium, each mapping structure comprises a confidence value indicative of the confidence of the potential mapping.

In some embodiments of the non-transitory computer-readable storage medium, the processing of the output data comprises merging at least a portion of the mapping structures.

In some embodiments of the non-transitory computer-readable storage medium, the context data further comprises at least one mapping structure of the one or more mapping structures indicative of the potential mapping for the respective data point of the plurality of data points, the at least one mapping structure being associated with a portion of the mapping structures not having undergone the merging.

In some embodiments, the one or more programs also include instructions which, when executed by the one or more processors, cause the device to determine whether a confidence value associated with a merger of two or more mapping structures exceeds a predefined confidence threshold, and, in accordance with the determination that the confidence value exceeds the predefined confidence threshold, identify the merger of the two or more mapping structures as a definitive mapping.

In some embodiments of the non-transitory computer-readable storage medium, at least one definitive mapping of the one or more definitive mappings is based on a merging of at least a first mapping structure and a second mapping structure, with the first mapping structure having been determined based on processing the telemetry data in accordance with a first context discovery operation and the second mapping structure having been determined based on processing the telemetry data in accordance with a second context discovery operation, different from the first context discovery operation.

In some embodiments of the non-transitory computer-readable storage medium, the processing of the telemetry data in accordance with the one or more context discovery operations comprises processing the telemetry data in accordance with one or more token interpretation operations, one or more context translation operations, and one or more neural network operations.

In some embodiments of the non-transitory computer-readable storage medium, the processing of the telemetry data in accordance with the one or more token interpretation operations comprises identifying one or more tokens of text data associated with a respective data point of the plurality of data points. The processing of the telemetry data in accordance with the one or more token interpretation operations also comprises determining a mapping structure of at least one token of the one or more tokens to a predefined token of a predefined token set based on at least a portion of the at least one token matching the predefined token. The processing of the telemetry data in accordance with the one or more token interpretation operations also comprises determining a confidence value for the mapping structure based at least on a character length of the portion of the at least one token and a character length of the predefined token.

In some embodiments of the non-transitory computer-readable storage medium, the one or more tokens of the text data associated with the respective data point are identified by at least one of splitting the text data based on recurring characters of the text data, splitting the text data based on one or more delimiter characters of the text data, splitting the text data based on one or more alphabetic characters following one or more numerical characters of the text data, and splitting the text data based on one or more numerical characters of the text data.

In some embodiments of the non-transitory computer-readable storage medium, the text data associated with the respective data point comprising one or more of a point name of the respective data point, a textual description of the respective data point, a data type of the respective data point, a unit of measure of the respective data point, one or more enumeration labels of the respective data point, one or more defined property names of the respective data point, and one or more tags of the respective data point.

In some embodiments of the non-transitory computer-readable storage medium, the processing of the telemetry data in accordance with the one or more context translation operations comprises identifying, for a respective data point, metadata associated with the respective data point. In some embodiments, the processing of the telemetry data in accordance with the one or more context translation operations also comprises processing the metadata in accordance with a context translation rule set, and, based on the processing, determining one or more mapping structures indicative of a potential mapping of a portion of the metadata to one or more predefined assets and a confidence value for the potential mapping.

In some embodiments of the non-transitory computer-readable storage medium, the processing of the telemetry data in accordance with the one or more neural network operations comprises identifying, for a respective data point, metadata associated with the respective data point. In some embodiments, the processing of the telemetry data in accordance with the one or more neural network operations also comprises processing the metadata in accordance with one or more models, the one or more models each trained to predict a potential mapping of a particular portion of the metadata of the respective data point. In some embodiments, the processing of the telemetry data in accordance with the one or more neural network operations also comprises determining, based on the processing, one or more mapping structures indicative of a potential mapping of portion of the metadata to one or more predefined assets and a confidence value for the potential mapping.

In some embodiments of the non-transitory computer-readable storage medium, the processing of the output data comprises processing the output data in accordance with a point role template set to generate one or more point role mapping structures. In some embodiments, the processing of the output data in accordance with the point role template set comprises determining, for a respective data point and a respective point role template of a point role template set, a point role match confidence value based at least on an identification of a concept term associated with both a mapping structure associated with the respective data point and the respective point role template. In some embodiments, the processing of the output data in accordance with the point role template set also comprises generating, based at least on the point role match confidence value, a point role mapping structure comprising at least an indication of the respective data point and an indication of the respective point role template, with the context data further comprising the one or more point role mapping structures.

In some embodiments of the non-transitory computer-readable storage medium, the processing of the output data in accordance with the point role template set also comprises generating a ranked listing of the point role match confidence values, with the point role mapping structure being generated based on having the highest point role match confidence value of the ranked listing of the determined point role match confidence values.

In some embodiments of the non-transitory computer-readable storage medium, the processing of the output data comprises generating a ranked list of one or more mapping structures associated with a particular asset in order of respective confidence values. In some embodiments, the processing of the output data also comprises determining, based on the ranked list, an asset type for a respective asset.

In some embodiments, one or more programs also include instructions which, when executed by the one or more processors, cause the device to cause transmission of the generated context data to a semantic model generation application.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a block diagram of a system configured to communicate via a network, in accordance with one or more embodiments described herein;

FIG. 2 illustrates a block diagram of an apparatus that may be specifically configured, in accordance with one or more embodiments described herein;

FIG. 3 illustrates a flow diagram of operations related to generating context data, in accordance with one or more embodiments described herein;

FIG. 4 illustrates a flow diagram of operations related to token interpretation of a data point, in accordance with one or more embodiments described herein;

FIG. 5 illustrates a flow diagram of operations related to context translation of a data point, in accordance with one or more embodiments described herein;

FIG. 6 illustrates a flow diagram of operations performed in accordance with one or more statistical classification operations for a data point, in accordance with one or more embodiments described herein;

FIG. 7 illustrates a flow diagram of operations performed in accordance with identifying definitive mappings for a data point, in accordance with one or more embodiments described herein;

FIG. 8 illustrates a flow diagram of operations performed in accordance with an asset type for a data point, in accordance with one or more embodiments described herein;

FIG. 9A illustrates a flow diagram of operations performed in accordance with mapping a data point to a point role, in accordance with one or more embodiments described herein; and

FIG. 9B illustrates an example representation of a point role, in accordance with one or more embodiments described herein.

### DETAILED DESCRIPTION

Various embodiments of the present invention now will be described more fully hereinafter with reference to the accompanying drawings, in which some, but not all embodiments of the invention are shown. Indeed, the invention can be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

In the following detailed description, numerous specific details are set forth in order to provide a thorough understanding of the various described embodiments. How-ever, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

The phrase ‘one or more’ includes a function being performed by one element, a function being performed by more than one element, e.g., in a distributed fashion, several functions being performed by one element, several functions being performed by several elements, or any combination of the above.

It will also be understood that, although the terms “first,” “second,” etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The phrases “in an embodiment,” “in one embodiment,” “according to one embodiment,” and the like generally mean that the particular feature, structure, or characteristic following the phrase can be included in at least one embodiment of the present disclosure, and can be included in more than one embodiment of the present disclosure (importantly, such phrases do not necessarily refer to the same embodiment).

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some embodiments, or it can be excluded.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

As used herein, the term “computer-readable storage medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable storage medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein can also include, for example, a baseband integrated circuit or applications processor integrated circuit for a mobile phone or a similar integrated circuit in a server, a cellular network device, other network device (such as a core network apparatus), field programmable gate array, and/or other computing device.

As described above, a plant, such as an industrial plant, and/or building containing a vast amount of assets and an associated automation system for the assets can be complex and may comprise tens of thousands of data points of sensors, controllers, actuators, and/or the like that are associated with the assets. For this reason, analytics, such as predictive maintenance models, fault detection processes, model-based predictive control algorithms, and/or the like, can be deployed to process time-series data of the data points in order to diagnose various conditions of the asset system, predict faults within the asset system, optimize performance, gain various insights, and/or the like. Given the large number of assets and associated data points, as well as the many analytical operations needed to be constantly executed for the asset system, the process of configuring the analytics should be automated for purposes of efficiency and cost savings.

A key factor for automatically-enabled analytics is the generation of a digital model, or semantic model, for the asset system. Such digital models represent and describe the arrangement of real-world assets and provide context for those assets. A digital model is be defined with a common vocabulary and established by a formal domain model (e.g., a domain ontology). Digital models may be used to allow for the analysis of devices or performing analytics and/or customized manual programming for assets, including but not limited to advanced diagnostics, energy management, performance optimization, and/or the like.

In some examples, generation of a digital model is an expensive, time-consuming process. For example, the digital model may be generated using manual human intervention, requiring in-depth information harvesting and investigations of potentially thousands of assets and an immense amount of data points for the assets, as well as determination of context for the asset system including an identification of how various assets are interconnected, in order to accurately recreate the asset system as a digital model. In this regard, an onboarding of assets with respect to a digital model of an asset system takes weeks or even months depending on the size of the asset system. Such a time delay results in issues, such as faults, failures, or inefficiencies of the asset system going undetected while awaiting an onboarding of the assets to the digital model.

To address these and/or other issues, a system, method, and non-transitory computer readable storage medium are disclosed herein that provide efficient context discovery for an asset system. In this regard, the system, method, and non-transitory computer readable storage medium integrate a plurality of context discovery operations and reasoning techniques further described herein to provide automatic and efficient generation of context data for an asset system. The efficient generation of such context data increases an onboarding speed for an asset system by determining definitive mappings of data points to assets, as well as provides suggested mappings with confidence in order to enhance the onboarding speed of assets that may not be definitively mapped. In this regard, faster onboarding of asset systems and automatically-enabled analytics is achieved, additionally with increased quality and reliability of the generated context data while avoiding disruptive factors such as human error.

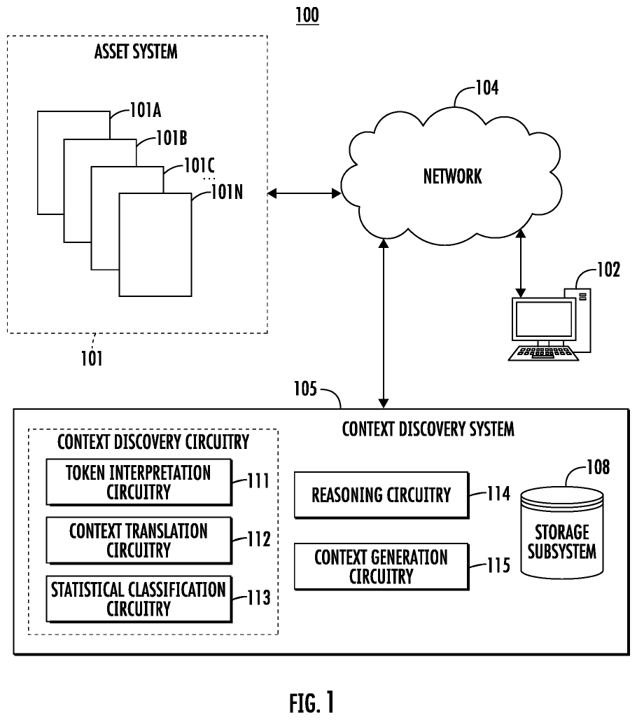

Referring now to FIG. 1, an example environment 100 within which embodiments disclosed herein may operate is illustrated. It will be appreciated that the environment 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of such an environment, numerous other configurations may also be employed.

In some embodiments, a context discovery system 105 is configured to interact with one or more computing devices 102. In some embodiments, the computing device 102 is an administrative device, such as a computing device overseen by a system administrator, data engineer, and/or the like that is associated with an asset system. Example computing devices 102 may include, without limitation, smart phones, tablet computers, laptop computers, wearables, personal computers, enterprise computers, and/or the like.

In some embodiments, the computing device 102 executes software, such as one or more applications related to semantic model generation. In some embodiments, the context discovery system 105 is configured to receive, generate, and cause transmission of data, such as generated context data, to the computing device(s) 102 (e.g., an administrative device), and in some embodiments, directly to the semantic model generation software of the computing device 102, allowing for automatic or semi-automatic generation of a digital model. In this regard, a data engineer is provided with at least a partially generated digital model based on the generated context data that defines one or more definitive and/or suggested mappings in order to facilitate efficient review and/or completion of the model by the data engineer.

In some embodiments, the context discovery system 105 is configured to receive data associated with one or more assets 101A-101N of an asset system 101. In some embodiments, the received data is telemetry data that includes a plurality of data points obtained from, for example, an automation system for the asset system that includes one or more sensor devices configured to monitor one or more assets (e.g., a boiler, compressor, pump, fan, valve, and/or other type of equipment or device) or in some embodiments, directly from the assets. Examples of sensor devices whose readings are used to generate such telemetry data include pressure (e.g., water pressure, air pressure, etc.) sensor devices, temperature sensor devices, motion sensor devices, environmental sensor devices, fan angular motion sensor devices, cameras, audio recorders, and/or the like.

In some embodiments, the context discovery system 105 communicates with the computing device(s) 102 and/or the assets 101A-101N and/or associated automation system and/or sensor devices and/or other computing devices using a network 104. The network 104 includes any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 104 may include a cellular telephone, an 802.11, 802.16, 802.20, and/or WiMax network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the context discovery system 105.

In some embodiments, the context discovery system 105 comprises context discovery circuitry including token interpretation circuitry 111, context translation circuitry 112, and statistical classification circuitry 113 configured to perform one or more context discovery operations. In some embodiments, the context discovery circuitry comprises algorithms employing techniques such as machine learning, deep learning, tokenization of names and string and/or substring matching, clustering, and/or the like that, if necessary, may be executed in parallel such that each context discovery operation determines certain pieces of context for a respective asset.

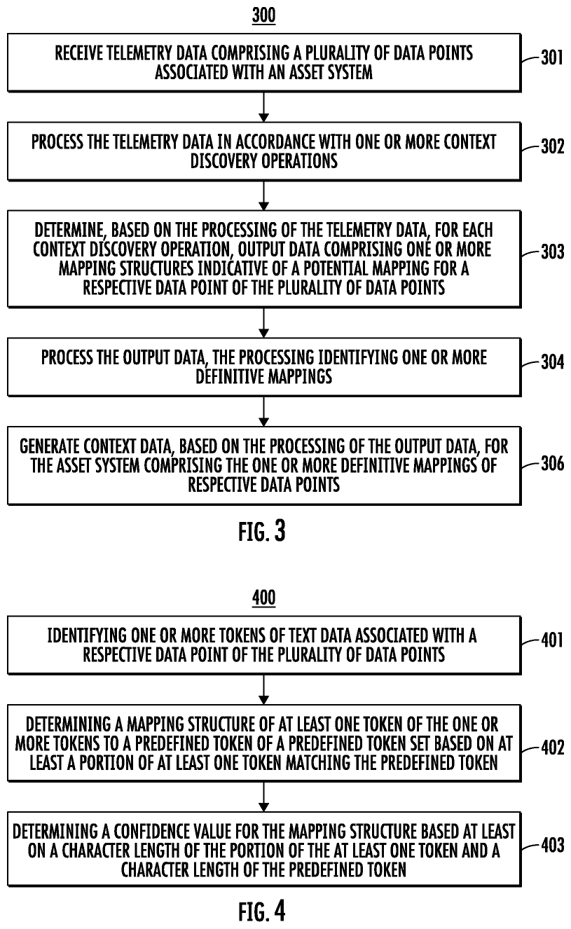

In an embodiment, the token interpretation circuitry 111 comprises one or more predefined functions, algorithms and/or instructions for performing one or more token interpreation operations on received telemetry data, such as analysis of text data associated with the telemetry data, identifying one or more tokens of text data associated with a respective data point, determining a mapping structure of at least one token of the one or more tokens to a predefined token of a predefined token set and/or the like. Additional details regarding the token interpretation circuitry 111 and the analysis of text data for a data point is further described herein in connection with FIG. 4.

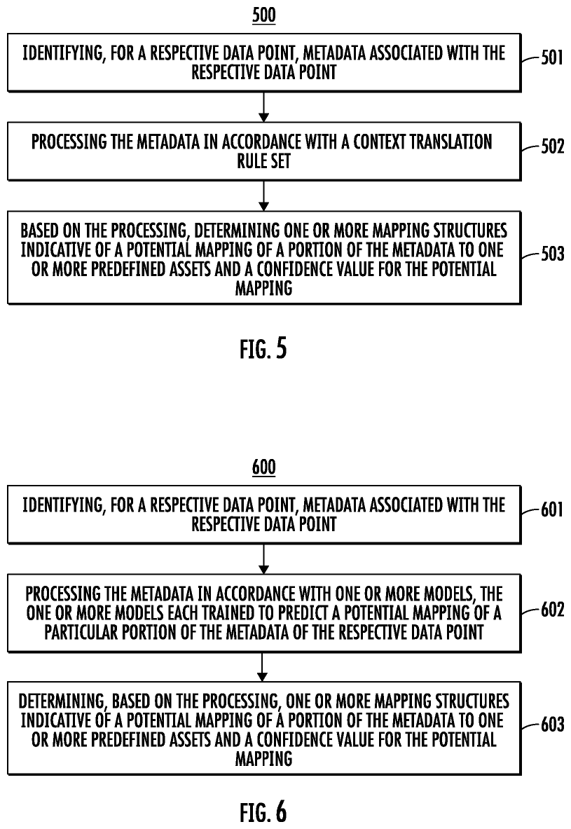

In some embodiments, the context discovery circuitry comprises context translation circuitry 112. In an embodiment, the context translation circuitry 112 comprises one or more predefined functions and/or instructions for performing one or more context translation operations on received telemetry data, such as processing metadata of a data point in accordance with one or more context translation rules of a context translation rule set, and/or the like. Additional details regarding the context translation circuitry 112 and the context translation rule set is further described herein in connection with FIG. 5.

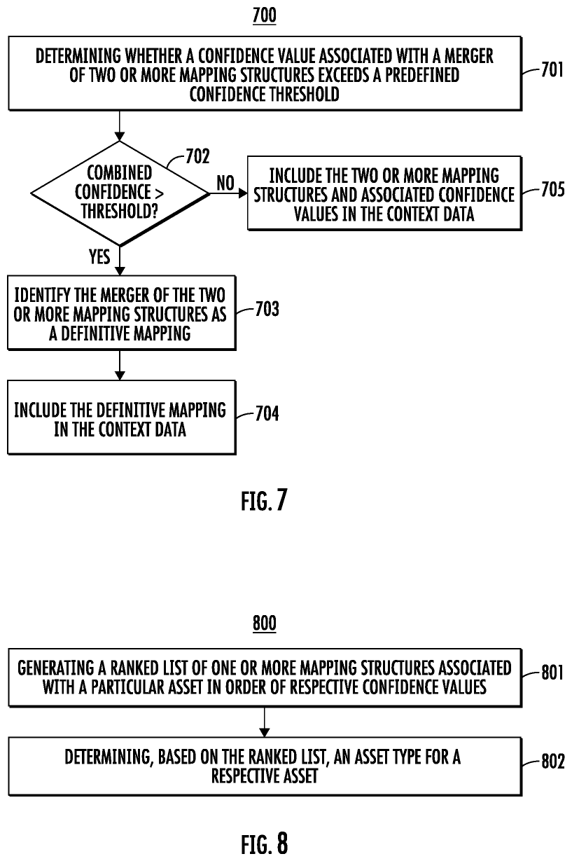

In some embodiments, the context discovery circuitry comprises statistical classification circuitry 113. In an embodiment, statistical classification circuitry 113 comprises one or more predefined functions and/or commands for processing of telemetry data in accordance with the one or more statistical classification operations, such as processing metadata of a data point in accordance with one or more statistical classification models to determine one or more mapping structures indicative of a potential mapping of portion of the metadata to one or more predefined assets, and/or the like. Additional details regarding the statistical classification circuitry 113 is further described herein in connection with FIG. 6.

In some embodiments, the context discovery system 105 comprises reasoning circuitry 114. In an embodiment, the reasoning circuitry 114 comprises one or more predefined functions, algorithms and/or instructions for processing output data generated by one or more context discovery operations, such as, for example, merging a portion of the mapping structures generated by context discovery operations performed by one or more of the token interpretation circuitry 111, context translation circuitry 112, or the statistical classification circuitry 113. Additional details regarding the reasoning circuitry 114 is further described herein in connection with FIGS. 7, 8, and 9A.

In some embodiments, the context discovery system 105 comprises context generation circuitry 115. In an embodiment, the context generation circuitry 115 comprises one or more predefined functions, algorithms and/or instructions for generating context data based on one or more definitive mappings determined by reasoning circuitry 114. Additional details regarding the context generation circuitry 115 is further described herein in connection with FIG. 3.

In some embodiments, the context discovery system 105 includes or otherwise in communication with a storage subsystem 108. In some embodiments, the storage subsystem stores data related to a domain ontology related to a digital model and/or the generation thereof. The domain ontology includes data related to entities, attributes, and relationships that describe a specific domain. The entities and formalisms in the ontology together support a means to strongly type the data relating to that domain. The ontology is a semantic formalism that describes metadata that describes a domain. The ontology describes instances of domain objects consistent with this ontology, and ruled by the formalisms therein, such that reasoning may occur across the elements so defined. This data is supported by a persistence model via the storage subsystem 108, a flat file, and/or other file storage mechanism for storage and processing. In some embodiments, the data defined by this ontology allows for data points used or produced by an asset system to be unambiguously described in relationship to the system of which it is a part, or by which it is employed.

In some embodiments, the storage subsystem 108 is configured to store received data as well as one or more models (e.g., statistical classification models that may comprise neural network models and/or the like) and data associated with the one or more models utilized by the context discovery system 105, such as stored historical and/or training data. Additional data, such as output data generated by context discovery operations and/or generated context data may also be stored in storage subsystem 108. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

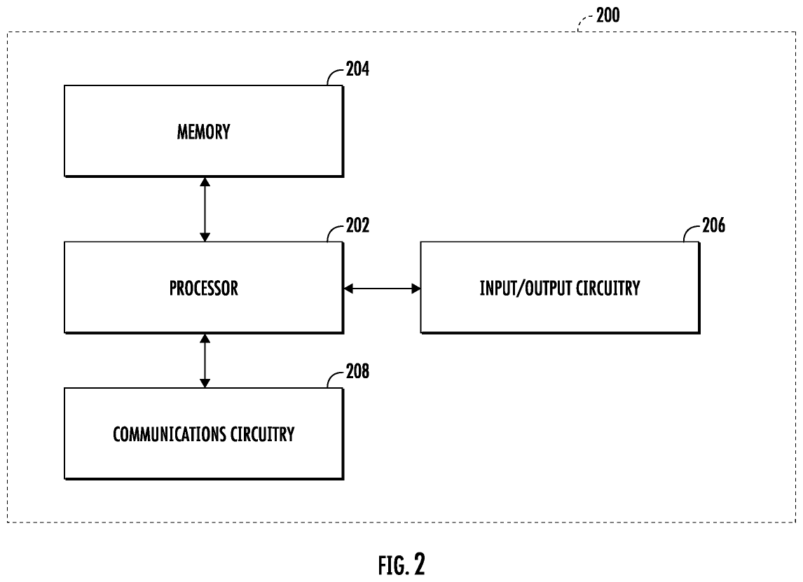

The context discovery system 105 and/or the computing device(s) 102 are embodied by one or more computing systems, such as the example apparatus 200 shown in FIG. 2. The apparatus 200 includes processor 202 and memory 204, and can include input/output circuitry 206 and communications circuitry 208. In some embodiments, the apparatus 200 is configured to execute the operations described herein. Although these components 202-208 are described with respect to functional limitations, it should be understood that the particular implementations necessarily include the use of particular hardware. It should also be understood that certain of these components 202-208 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) is in communication with the memory 204 via a bus for passing information among components of the apparatus. The memory 204 is non-transitory and may include, for example, one or more volatile and/or non-volatile memories. In other words, for example, the memory 204 is an electronic storage device (e.g., a computer-readable storage medium). The memory 204 is configured to store information, data, content, applications, instructions, or the like for enabling the apparatus to carry out various functions in accordance with example embodiments disclosed herein.

The processor 202 may be embodied in a number of different ways and may, for example, include one or more processing devices configured to perform independently. In some non-limiting embodiments, the processor 202 includes one or more processors configured in tandem via a bus to enable independent execution of instructions, pipelining, and/or multithreading. The use of the term “processing circuitry” is understood to include a single core processor, a multi-core processor, multiple processors internal to the apparatus, and/or remote or “cloud” processors.

In some embodiments, the processor 202 is configured to execute instructions stored in the memory 204, storage subsystem 108, and/or circuitry otherwise accessible to the processor 202, such as the token interpretation circuitry 111, context translation circuitry 112, and/or the statistical classification circuitry 113. In some embodiments, the processor 202 may be configured to execute hard-coded functionalities. As such, whether configured by hardware or software methods, or by a combination thereof, the processor 202 represents an entity (e.g., physically embodied in circuitry) capable of performing operations according to embodiments disclosed herein while configured accordingly. Alternatively, as another example, when the processor 202 is embodied as an executor of software instructions, the instructions specifically configure the processor 202 to perform the algorithms and/or operations described herein when the instructions are executed.

In some embodiments, the apparatus 200 can include input/output circuitry 206 that is in communication with the processor 202 to provide output (e.g., to a user) and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae.

It is also noted that all or some of the information discussed herein is based on data that is received, generated and/or maintained by one or more components of apparatus 200. In some embodiments, one or more external systems (such as a remote cloud computing and/or data storage system) may also be leveraged to provide at least some of the functionality discussed herein.

Referring now to FIG. 3, a method 300 illustrates operations performed to generate context data for an asset system. In some embodiments, the context discovery system 105 receives, accesses or otherwise acquires telemetry data of the asset system 101 that comprises data points that include information about the assets, such as, for example, names of assets, names of properties of the assets, manufacturer-related data about the asset (e.g., manufacturer name, model number, nominal power, nominal speed, etc.), raw data of properties (e.g., time-series data), and/or hierarchical data for the assets, such as upstream and/or downstream relationships between assets. In this regard, data points are processed in accordance with one or more context discovery operations to determine output data comprising one or more mapping structures indicative of a potential mapping for a respective data point. The context discovery system 105 then merges a portion of the mapping structures produced by the context discovery operations using a probabilistic approach which increases a confidence of the mapping structures that are determined from several of the context discovery operations. In this way, the combination of several of the different context discovery operations performed by the context discovery circuitry produces mappings of data points that are more complete and have a higher likelihood to be correct (e.g., a higher confidence) compared to applying only one context discovery operation.

At operation 301, the context discovery system 105, such as the processor 202, communications circuitry 208, and/or the like, is configured to receive or otherwise access telemetry data comprising a plurality of data points associated with an asset system.

The telemetry data can be received or otherwise accessed from a variety of sources. For example, in some embodiments, the telemetry data is received (e.g., over network 104) from one or more sensor devices and/or other monitoring devices associated with the assets, an automation system (e.g., a building automation system) for the asset system, and/or directly from assets. In some examples, telemetry data may be received from an intermediary device between the assets and the context discovery system 105, such as a computing device associated with and/or embodied by an asset that is configured to monitor and/or control related sensor devices and/or assets. In some examples, rather than being directly received from a source such as the assets, sensor device(s), and/or computing devices associated with the assets, the telemetry data may be received in an indirect manner, such as by way of input/output circuitry 206 and/or storage subsystem 108. In this regard, the telemetry data may be previously collected and stored, prior to being accessed by the context discovery system 105 for processing.

Regardless of how the telemetry data is received, the telemetry data comprises data points associated with one or more assets. Each data point is associated with a respective asset and includes information about the asset. Such information may include a name of the asset, names of properties of the asset, manufacturer-related data, raw data values of the properties such as time-series data, hierarchical data such as indications of other assets and/or properties of other assets that the asset may be associated with or have some connection to, and/or other information. In some embodiments, data points may also include static properties of an asset, such as the volume of a room, a capacity, a specific vendor name of the asset, and/or other static information.

In some examples, the asset system for which the data points are collected may have been in operation for some time, may have been assembled and/or configured at different times, may have been assembled and/or configured by a plurality of different engineers, and/or the like such that the data points may lack data and/or may not follow a standardized naming convention. In some examples, a data point contains human-readable information related to a function, however in other examples, another data point may contain information in a manner that is not immediately decipherable by a human. Additionally, in some examples, the data point may not be machine processable without human intervention or manual mapping to a more standard identifier. In some examples, some data points may indicate a number of properties of an asset but lack values (e.g., time-series data) for a portion of the properties. As one example, two boiler systems may have been configured at different times and/or by different engineers, resulting in different naming conventions, such that a point name of one boiler system is “LeftBoiler” while the asset name of the other boiler system is “Right_BLR.”

In this regard, each data point is processed using one or more context discovery operations in order to gain insight into and determine information about the data point, such as what role the data point plays within the asset system, what conceptual entity the data point should be mapped to in the digital model of the asset system, what type of asset the data point is associated with, and/or other information in order to accurately represent the data point within the digital model.

At operation 302, the context discovery system 105, such as the token interpretation circuitry 111, context translation circuitry 112, statistical classification circuitry 113, processor 202, and/or the like, is configured to process the telemetry data in accordance with one or more context discovery operations. In some embodiments, a particular data point is processed in accordance with as many context discovery operations as appropriate for the particular data point. For example, a context discovery operation that analyzes time-series data of a data point may not be performed on a data point that lacks time-series data.

In some embodiments, context discovery operations are classified as either token interpretation operations (e.g., operations performed by token interpretation circuitry 111), context translation operations (e.g., operations performed by context translation circuitry 112), or statistical classification operations (e.g., operations performed by statistical classification circuitry 113). Multiple context discovery operations under each class of context discovery operations may be performed for a particular data point. In this regard, each context discovery operation discovers certain pieces of context about the data point in its own manner. The processing of the telemetry data in accordance with multiple context discovery operations provides technical improvements such as, but not limited to, improving efficiency and improving accuracy, such that multiple potential mappings may be determined for data points resulting in a more accurate mapping.

Regardless of the classification of context discovery operations, each context discovery operation provides an output of at least one mapping structure. As shown at operation 303, the context discovery system 105, such as the token interpretation circuitry 111, context translation circuitry 112, statistical classification circuitry 113, processor 202, and/or the like, is configured to determine, based on the processing of the telemetry data, for each context discovery operation, output data comprising one or more mapping structures indicative of a potential mapping for a respective data point of the plurality of data points. The mapping structure comprises a data structure, such as an array, list, or other similar data structure that includes information related to a potential mapping. The potential mapping is a mapping of the data point or a portion of the data point to an asset, property, entity, tag, aspect value, or other information defined in the formal domain ontology for a digital model. In this regard, mapping structures provide clues as to the identity and purpose of the particular data point within the system.

As one non-limiting example, a mapping structure may include a mapping of an asset name of the data point to an asset type defined by the ontology. For example, an asset name “AHU1” may be mapped to an asset type of “AirHandlingUnit.” In some embodiments, the mapping structure comprises a confidence value indicative of the confidence of the potential mapping (e.g., a likelihood the potential mapping is correct). The confidence value is a normalized confidence value (e.g., a value between 0 and 1) in some embodiments. The determination of confidence values may be based on the respective context discovery operation as described further herein. Continuing with the example above, the mapping structure including an array of [‘AHU1’, ‘AirHandlingUnit’, 0.9] indicates that a data point with the point name substring of ‘AHU1’ is potentially related to an asset type of ‘AirHandlingUnit’ with a 90% confidence.

In some embodiments, processing the telemetry data in accordance with the one or more context discovery operations comprises processing the telemetry data in accordance with one or more token interpretation operations, e.g., via token interpretation circuitry 111. The token interpretation operations include one or more string matching and/or splitting operations. In this regard, text data associated with a data point is processed to identify tokens (e.g., words, phrases, or the like) that are then mapped to data within the domain ontology in order to determine potential mappings for the data point. The text data associated with a data point that is processed to identify tokens may include a point name of the respective data point, a textual description, a data type (e.g., ‘integer,’ ‘string,’ ‘float,’ etc.), a unit of measure of the respective data point, one or more enumeration labels of the respective data point, one or more defined property names of the respective data point (e.g., as defined by an associated communication protocol such as LonWorks, Building and Automation Control Networks (BACnet), and/or the like), and/or one or more tags of the respective data point.

Turning to FIG. 4, a method 400 illustrates operations related to performing one or more token interpretation operations. At operation 401, the context discovery system 105, such as the token interpretation circuitry 111, processor 202, and/or the like, is configured to identify one or more tokens of text data associated with a respective data point of the plurality of data points. In some embodiments, for a respective data point, more than one token interpretation operation is performed, and each token interpretation operation identifies tokens in a different manner.

As one example, the data point may be processed in accordance with a token interpretation operation that splits the text data based on recurring characters within the text data. For example, if the data point comprises the text data “Floor1VAV1SpaceTemp,” the splitting of the text data in accordance with the camel case token interpretation operation yields the tokens ‘Floor,’ ‘VAV,’ ‘Space,’ and ‘Temp.’

As another example, the data point may additionally or alternatively be processed in accordance with a delimiter token interpretation operation that splits the text data based on one or more delimiter characters of the text data. In some embodiments, delimiter characters may include non-alphanumeric characters, such as periods, decimal points, commas, underscores, hyphens, and/or other symbols. For example, if the data point comprises the text data “Right_BLR,” the splitting of the text data in accordance with the delimiter token interpretation operation yields the tokens ‘Right’ and ‘BLR.’

As another example, the data point may additionally or alternatively be processed in accordance with a token interpretation operation that splits the text data based on one or more alphabetic characters following one or more numerical characters of the text data. In other words, this operation identifies tokens within a string that end with a digit, which may include tokens that are made up entirely of digits. For example, if the data point comprises the text data “Floor1VAV1SpaceTemp,” the splitting of the text data in accordance with the end digit token interpretation operation yields the tokens ‘Floor1,’ and ‘VAV112.’ In another example, the processing of text data ‘117FloorVAV3SpaceTemp’ in accordance with the end digit token interpretation operation yields the tokens ‘117,’ and ‘FloorVAV3.’

As another example, the data point may additionally or alternatively be processed in accordance with a token interpretation operation that splits the text data based on one or more numerical characters of the text data. In other words, this operation identifies tokens within a string that start from the beginning of the text data and end with a digit. For example, if the data point comprises the text data “Floor1VAV1SpaceTemp,” the splitting of the text data in accordance with the name start end digit token interpretation operation yields the tokens ‘Floor1,’ and ‘Floor1VAV112.’ In another example, the processing of text data ‘117FloorVAV3SpaceTemp’ in accordance with the name start end digit token interpretation operation yields the tokens ‘117,’ and ‘117FloorVAV3.’

At operation 402, the context discovery system 105, such as the token interpretation circuitry 111, processor 202, and/or the like, is configured to determine a mapping structure of at least one token of the one or more tokens to a predefined token of a predefined token set based on at least a portion of the at least one token matching the predefined token. For example, in some embodiments, the formal domain ontology for the digital model includes a predefined token set, such as a lexicon or synonym dictionary, that includes predefined tokens for the digital model. In this regard, for a respective token interpretation operation as described above, the one or more identified tokens are compared to at least a portion of the predefined token set in order to determine a match. For example, predefined tokens in an example predefined token set for a radiator asset may include the predefined tokens “Radiator” and “Rad.” In this regard, a mapping structure for text data that includes the token “radiator” may be generated for both of the predefined tokens, e.g., [‘radiator’, ‘Radiator’], [‘radiator’, ‘Rad’].

In some embodiments, a confidence value is determined for the mapping structure. In some embodiments, tokens that are matched to an existing phrase in the lexicon (e.g., a predefined token) may be assigned a constant confidence value (e.g., a value of 0.6 or 0.7). In some other embodiments, as shown at operation 403, the context discovery system 105, such as the token interpretation circuitry 111, processor 202, and/or the like, is configured to determine a confidence value for the mapping structure based at least on a character length of the portion of the at least one token and a character length of the predefined token. For example, one or more predefined confidence values may be encoded into the lexicon and be associated with one or more predefined tokens. For example, a token, “setpoint,” matched to a predefined token “setpoint” (e.g., a matching of all eight characters) is assigned a confidence of 1.0, or 100%. If the token “setpoint” matches to a predefined token “stp,” it may be assigned a confidence of 0.7, or 70%. Further, if the token “setpoint” matches to a predefined token “SP,” there can be multiple candidates (e.g., setpoint, static pressure, etc.) which may each be assigned a confidence of 0.5, or 50%. In this regard, the longer a token is, the higher confidence value that is assigned. For example, while ‘humidity’ results in a 100% confidence of mapping to ‘humidity,’ ‘humid’ may result in a 90% confidence of mapping to ‘humidity,’ and ‘hum’ may result in a 75% confidence of mapping to ‘humidity.’

In some embodiments, processing the telemetry data in accordance with the one or more context discovery operations comprises processing the telemetry data in accordance with one or more context translation operations, e.g., via context translation circuitry 112. The context translation operations include one or more rule-based operations for analyzing metadata of a data point. In this regard, metadata (e.g., data about data, such as engineering units, value range, etc.) associated with a data point is processed in accordance with one or more predefined rules to predict potential mappings for the data point.

Turning to FIG. 5, a method 500 illustrates operations related to performing one or more context translation operations. At operation 501, the context discovery system 105, such as the context translation circuitry 112, processor 202, and/or the like, is configured to identify, for a respective data point, metadata associated with the respective data point. Examples of metadata identified for a data point include one or more of engineering units used by the data point (e.g., degrees, liters, etc.), a minimum-to-maximum range for a value of the data point (e.g., 0-100, 0-1, etc.), an array of enumeration labels for the data point (e.g., {‘occupied,’ ‘unoccupied,’ ‘employee hours’}, {‘enabled,’ ‘disabled’}, {‘alarm,’ ‘normal’}, {‘pump1,’ ‘pump2,’ ‘pump3’}), tags for the data point (e.g., tags as defined by an associated software infrastructure such as Niagara, Haystack, or the like, or custom tags that may be defined using a custom tag dictionary), property names of network variables that may include network variable outputs (e.g., ‘nvoSpaceTemp,’ ‘nvoCoolOutput’), network variable inputs (e.g., ‘nviDischAirTemp,’ ‘nviSetPoint’), and/or network configuration properties (e.g., ‘nciSetpoints_occupiedCool’), and/or other metadata.

At operation 502, the context discovery system 105, such as the context translation circuitry 112, processor 202, and/or the like, is configured to process the metadata in accordance with a context translation rule set. For example, the context translation circuitry 112 accesses a context translation rule set (e.g., stored in storage subsystem 108) in order to execute one or more predefined context translation rules using the identified metadata in order to predict information about the data point.

As one example, an execution of an example context translation rule may infer that a data point having a minimum-to-maximum value range of 1000-5000 is related to a revolutions-per-minute (RPM) reading. As another example, an execution of an example context translation rule may infer that a data point having a minimum-to-maximum value range of 0-1 is related to a switch. As another example, an execution of an example context translation rule may infer that a data point having a minimum-to-maximum value range of 0-100 is related to a percentage reading. As another example, an execution of an example context translation rule may infer that a data point having engineering units of pascals is related to measuring pressure.

At operation 503, the context discovery system 105, such as the context translation circuitry 112, processor 202, and/or the like, is configured to determine, based on the processing of the metadata with the context translation rule set, one or more mapping structures indicative of a potential mapping of a portion of the metadata to one or more predefined assets and a confidence value for the potential mapping. For example, a mapping structure may include a mapping of an engineering unit of the data point to an aspect value defined by the ontology. In this regard, an engineering unit ‘Kelvin’ may be mapped to an aspect value of ‘Temperature’ of the MeasureType aspect. In some embodiments, the mapping structure comprises a confidence value indicative of the confidence of the potential mapping (e.g., the likelihood of the potential mapping being correct). The confidence value may be a normalized confidence value (e.g., a value between 0 and 1) in some embodiments. The determination of confidence values may be based on the respective context discovery operation. In some embodiments, the mapping structure comprises an indication of the language in which the engineering unit is specified (e.g., ‘English,’ ‘Spanish,’ ‘German,’ etc.). Continuing with the example above, the mapping structure may comprise an array of data, such as [‘Degree Fahrenheit,’ ‘English,’ ‘Temperature,’ 0.9], indicating that a datapoint with the engineering unit substring of ‘Degree Fahrenheit’ is potentially related to an aspect value of ‘Temperature’ with a 90% confidence.

As another example, a mapping structure comprising an array of [‘KubikmeterProSekunde,’ ‘German,’ ‘VolumetricFlowRate,’ 0.85] indicates that a data point with the engineering unit substring of ‘KubikmeterProSekunde’ is potentially related to an aspect value of ‘VolumetricFlowRate’ with an 85% confidence. In a further example, a mapping structure comprising an array of [‘KilovoltAmpères,’ ‘French,’ ‘Power,’ 0.9] indicates that a data point with the engineering unit substring of ‘KilovoltAmpères’ is potentially related to an aspect value of ‘Power’ with a 90% confidence. In yet another example, a mapping structure comprising an array of [‘° F.’, ‘English’, ‘Temperature’, 0.9] indicating that a data point with the engineering unit substring of ‘° F.’ is potentially related to an aspect value of ‘Temperature’ with a 90% confidence.

In some embodiments, the confidence value that is included within a mapping structure may be a predefined confidence value, e.g., based on the particular rule that is executed. In some embodiments, a confidence value is determined based on the overlap between text data of the data point and a corresponding matching term within the ontology. For example, in some embodiments, the overlap is determined by dividing the total number of overlapping characters by the total number of characters in the matching term within the ontology. For example, the text data ‘Temp’ and the ontology aspect value ‘Temperature’ yields a confidence value of 4/11, or approximately 36%. As another example, if the text data is “Temperatur” (e.g., due to a typographical error) and the aspect value in the ontology is “Temperature”, then the confidence value results in 10/11, or approximately 91%.

In some embodiments, processing the telemetry data in accordance with the one or more context discovery operations comprises processing the telemetry data in accordance with one or more statistical classification operations, e.g., via statistical classification circuitry 112. The statistical classification operations include one or more machine learning model-based operations for analyzing metadata of a data point and predicting potential mappings for portions of the metadata based on models specifically trained to predict various aspects of the data point.

Turning to FIG. 6, a method 600 illustrates operations related to performing one or more statistical classification operations. In some embodiments, statistical classification operations include operations utilizing probabilistic classifiers, such as neural networks, support vector machines, decision trees, linear classifiers, and/or other supervised classification algorithms. At operation 601, the context discovery system 105, such as the statistical classification circuitry 113, processor 202, and/or the like, is configured to identify, for a respective data point, metadata associated with the respective data point (e.g., as described above). At operation 602, the context discovery system 105, such as the statistical classification circuitry 113, processor 202, and/or the like, is configured to process the metadata in accordance with one or more models, the one or more models each trained to predict a potential mapping of a particular portion of the metadata of the respective data point.

For example, in an embodiment, the one or more models are trained neural network models that have been trained in a supervised manner using training data associated with a particular aspect of a data point. As one example, an example data point is processed using a neural network model specifically trained to predict a material type associated with a data point. The material type identifies what type of element is being measured, modified, consumed, moved and/or otherwise utilized by the asset associated with the data point. Examples of material types include water, oil, air, and/or the like. As another example, the example data point is processed using a neural network model specifically trained to predict a signal type associated with a data point. The signal type identifies what type of signal is associated the data point (e.g., an analog signal, digital signal, or multistate signal).

As another example, the example data point is processed using a neural network model specifically trained to predict a measure type associated with a data point. The measure type identifies what type of property of a process is being described the data point. Examples of measure types include temperature, pressure, speed, and/or the like. In this regard, training data is collected in the form of historical data, such as data points derived and collected from a variety of systems representing a variety of measurement types. For each collected data point, a correct annotation for the measurement type can be provided (e.g., by a data engineer and/or other subject matter expert), and the annotated data is then used as training data for the neural network model. The neural network model then iterates over the training data set multiple times to accurately learn mappings between, in this example, measurement types and textual data of a data point. In some embodiments, the training is completed once a prediction accuracy of the model is sufficiently high, e.g., greater than 95% of data points are classified correctly by the neural network model.

Other example trained models include trained neural network models specifically trained to predict what type of asset is associated with the data point, a distribution function of the data point (e.g., what type of function is being performed), a state of the asset associated with the data point (e.g., on/off, enabled/disabled, standby, etc.), and/or the like.

At operation 603, the context discovery system 105, such as the statistical classification circuitry 113, processor 202, and/or the like, is configured to determine, based on the processing, one or more mapping structures indicative of a potential mapping of portion of the metadata to one or more predefined assets and a confidence value for the potential mapping. Continuing with the example above, a neural network model is trained accordingly such that a new data point, for example, a data point having the name “AHU1SuppTemp” may be provided to the model as input, and the model correctly predicts a measure type of “Temperature” mapped to the data point, with an estimated confidence value for the mapping.

For example, for a sample input point with a point name “AHU1SuppTemp”, the statistical classification circuitry may produce the following example mapping structures:
[‘AHU1SuppTemp’, ‘Temperature’, ‘MeasureType’, 0.92],
[‘AHU1SuppTemp’, ‘SupplyAirLocation’, ‘DistributionLocationType’, 0.65],
[‘AHU1SuppTemp’, ‘AirHandlingUnit’, ‘ElementAssemblyType’, 0.75],
[‘AHU1SuppTemp’, ‘Analog’, ‘SignalType’, 0.95],
[‘AHU1SuppTemp’, ‘Input’, ‘SignalDirectionType’, 0.87],
   wherein the first mapping structure indicates that the data point is potentially related to an aspect value of ‘Temperature’ (of the MeasureType aspect) with a 92% confidence, the second mapping structure indicates that the data point is potentially related to an aspect value of ‘Supply AirLocation’ (of the DistributionLocationType aspect) with a 65% confidence, the third mapping structure indicates that the data point is potentially related to an aspect value of ‘AirHandlingUnit’ (of the ElementAssembly Type aspect) with a 75% confidence, the fourth mapping structure indicates that the data point is potentially related to an aspect value of ‘Analog’ (of the SignalType aspect) with a 95% confidence, and the fifth mapping structure indicates that the data point is potentially related to an aspect value of ‘Input’ (of the SignalDirectionType aspect) with a 87% confidence.

Turning back to FIG. 3, at operation 304, the context discovery system 105, such as the reasoning circuitry 114, processor 202, and/or the like, is configured to process the output data, the processing identifying one or more definitive mappings. In this regard, a plurality of mapping structures determined by the context discovery operations are processed, e.g., via reasoning circuitry 114. In this regard, as described above with respect to the various context discovery operations, a mapping structure includes indications of a potential mapping of a real-world entity (e.g., an asset) represented by its name or other identifier to a conceptual entity of the formal domain model (e.g., a class or instance) which a processed context discovery operation identifies as a likely meaning of the real-world entity. As described above, the mapping structure also includes a confidence value for the potential mapping, representing a likelihood that the potential mapping is correct.

For example, a mapping structure for a particular asset may take the form of [asset→asset type (class)], for example, [“AHU1”→“AirHandlingUnit”]. Furthermore, a confidence value for the mapping structure may be normalized to fall within the interval (0,1) (e.g., 0.9), and accordingly, the higher the value, the higher the confidence. In another example, a mapping structure for a property of the asset and their corresponding confidence values may take the form of [property→concept term and type (class or instance), confidence value]. For example:
[“RTU3RaFanEn”→“RoofTopUnit” (ElementAssembly), 0.93],
[“RTU3RaFanEn”→“ReturnAir” (DistributionLocation), 0.85],
[“RTU3RaFanEn”→“Fan” (Element), 0.95],
[“RTU3RaFanEn”→“Enabled” (ElementState), 0.7],
[“RTU3RaFanEn”→“PresentValue” (ControlPointFunction), 0.4],
and [“RTU3RaFanEn”→“BinaryState” (Measure), 0.4].

The mapping structure representation may also be applicable and extensible for representing other types of information (e.g., relationships between devices and properties). In some embodiments, the confidence values of the mapping structures are determined by their respective context discovery operations and/or can be derived from tests with real data (e.g., statistics), or they can be predefined based on historical experience (e.g., constant confidence values).

After the mapping structures are determined by the context discovery operations and collected (e.g., optionally temporarily stored in storage subsystem 108), the mapping structures are processed in order to determine elements of context data for the asset system. These elements include determination of definitive mappings for the asset system, determination of asset types for the asset system, and/or determination of point roles, e.g., a concept set describing the purpose of a data point within the asset system.

In some embodiments, the processing of the output data comprises merging at least a portion of the mapping structures in order to determine definitive mappings for the asset system. In this regard, mapping structures (including mapping structures determined by different context discovery operations of different classifications) are merged together. In this regard, the processing of mapping structures includes merging equivalent mapping structures as well as a processing of confirmed mapping structures (e.g., mapping structures with a confidence value of 1.0).

For example, mapping structures are considered equivalent if both their real world entity and conceptual entity are the same. Their confidence values, however, may be different. For instance, example equivalent mapping structures may be:
[“AHU1”→“AirHandlingUnit”, 0.9] and
[“AHU1”→“AirHandlingUnit”, 0.8].
   As such, the equivalent mapping structures are merged into one combined definitive mapping structure indicating a definitive mapping of the real-world entity to the conceptual entity. The merging of mapping structures in order to determine definitive mappings for the asset system provides technical improvements such as, but not limited to, improving accuracy of context data for a digital model. In some embodiments, the combined definitive mapping structure may be assigned an increased confidence value, which may be determined based on the confidence values of the equivalent mapping structures. For example, the confidence value for the combined definitive mapping structure may be determined using the following probabilistic formula,

$$combinedConfidenceValue = 1 - Π ( 1 - confidenceValuen ) Nn$$

with N being the number of mapping structures to merge. In this regard, the combined confidence value takes values in the interval (0, 1). As one example, equivalent mapping structures having confidence values of 0.6 and 0.8 results in a combined confidence value of 0.92, as determined by the above formula: 1−((1−0.6)*(1−0.8)).

In some embodiments, definitive mapping structures may be confirmed manually (e.g., by a data engineer, analyst or the like). In this regard, in some embodiments, when a definitive mapping is confirmed manually, the confidence value is assigned ‘1’ indicating that the mapping is correct (e.g., it is a fact). In some embodiments, once a definitive mapping is manually confirmed, processing may be performed such that all other mapping structures for the same asset may be disabled or deleted.

In some embodiments, a combined confidence value is compared to a predefined confidence threshold in order to determine whether the associated combination of the mapping structures should be represented as a definitive mapping when generating context data for the digital model. For example, two mapping structures having low confidence values results in a combined confidence value that is also low (e.g., less than 50% confidence). Turning to method 700 of FIG. 7, at operation 701, the context discovery system 105, such as the reasoning circuitry 114, processor 202, and/or the like, is configured to determine whether a confidence value associated with a merger of two or more mapping structures (e.g., a combined confidence value) exceeds a predefined confidence threshold.

At decision point 702, in accordance with a determination that the confidence value exceeds the predefined confidence threshold, the method 700 continues to operation 703, where the context discovery system 105, such as the reasoning circuitry 114, processor 202, and/or the like, is configured to identify the merger of the two or more mapping structures as a definitive mapping. In this regard, the mapping structures are merged and/or remain merged together when included in context data for the digital model. At operation 704, the context discovery system 105, such as the reasoning circuitry 114, processor 202, and/or the like, is configured to include the definitive mapping in the context data, the generation of which is further described below.

In accordance with a determination that the confidence value fails to exceed the predefined confidence threshold, the method 700 continues to operation 705, where the context discovery system 105, such as the reasoning circuitry 114, processor 202, and/or the like, is configured to include the two or more mapping structures and associated confidence values in the context data. In this regard, the mapping structures are unmerged and/or remain unmerged such that they may be reviewed by an engineer when processing the digital model. In this regard, the mapping structures are provided in context data along with their confidence values as a best guess to a mapping of the data point to an asset or the like for confirmation by an engineer, analyst, or the like.

In some embodiments, in addition to the determination of definitive mappings as described above, asset types for assets are also determined based on the output data including the mapping structures determined by the context discovery operations. In this regard, given the set of all remaining mapping structures (e.g., after the merging and/or manual confirmations described above), a prioritized list of the most likely asset types (e.g., Boiler, Chiller, Air Handling Unit, etc.) is derived for the asset associated with a particular data point. In some embodiments, asset types may be listed based on their associated confidence value.

Turning to method 800 of FIG. 8, at operation 801, the context discovery system 105, such as the reasoning circuitry 114, processor 202, and/or the like, is configured to generate a ranked list of one or more mapping structures associated with a particular asset in order of respective confidence values. For instance, an example ranked listing comprises [‘AHU1’, AirHandlingUnit, 0.95] as the top ranked asset mapping structure based on the confidence level. The example ranked listing may further comprise additional mapping structures with lesser confidence values that may map ‘AHU1’ to an asset type other than AirHandlingUnit.

In this regard, at operation 802, the context discovery system 105, such as the reasoning circuitry 114, processor 202, and/or the like, is configured to determine, based on the ranked list, an asset type for a respective asset, for example, by selecting the asset type of the top-ranked mapping structure having the highest confidence value.

In some embodiments, in addition to the determination of definitive mappings and asset types for a digital model of an asset system, the output data including the mapping structures determined by the context discovery operations is processed in accordance with a point role template set to generate one or more point role mapping structures. A point role mapping structure serves to identify the semantics of a particular property (e.g., the role a property plays in the asset). In the digital model, this may be expressed by attaching a point role to a property. A point role is a concept set such as a collection of strongly typed concept terms defined in the domain ontology (e.g., AirHandlingUnit, Temperature, etc.), which are discrete elements of different concept types (e.g., PlantType, SignalType, MeasureType, etc.) that together, provide an unambiguous description of the context of the property of the particular asset.

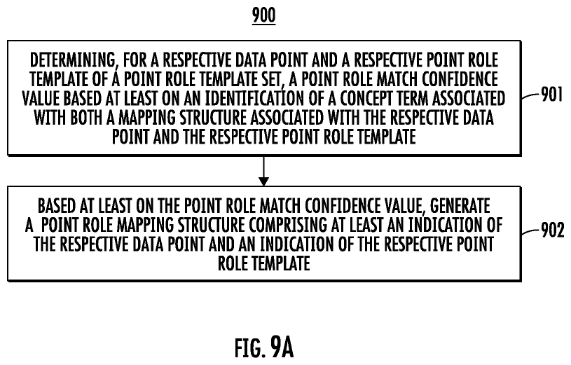

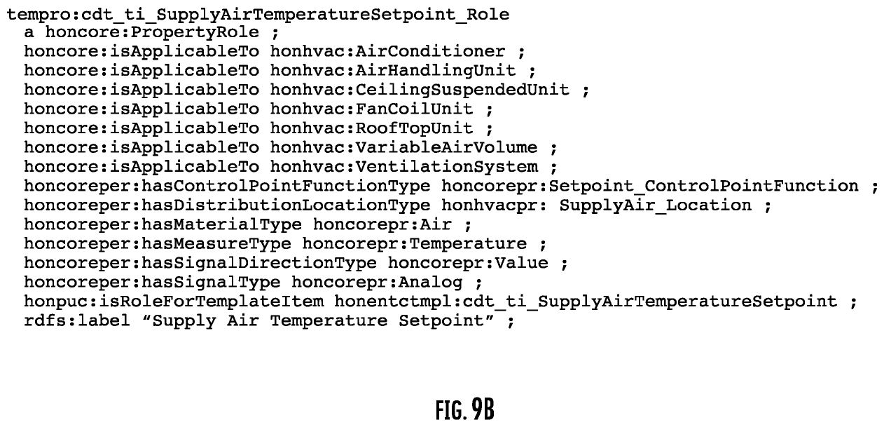

In this regard, an example point role is shown in FIG. 9B for the property ‘Supply AirTemperatureSetpoint.’ As shown, the point role includes asset names that the property is applicable to, such as ‘AirConditioner,’ ‘AirHandlingUnit,’ ‘FanCoilUnit,’ etc., as well as concept terms for concept types. For example, as shown, the ‘Supply AirTemperatureSetpoint’ property is associated with a MeasureType of ‘Temperature,’ a MaterialType of ‘Air,’ a SignalType of ‘Analog,’ etc.

Point roles may contain one concept term per concept type, but may not have to specify all concept types. In some cases, the point roles for a particular domain may be defined in predefined point role templates. In some instances, the point role templates define the properties and the point roles that the particular device can have (e.g., based on expert domain knowledge).

In some embodiments, the determination of the best matching point role (e.g., point role template) for a property is performed as a matching of the mapping structures associated with the property to the point roles defined in all the point role templates of the point role template set. If the asset type is known already (e.g., manually confirmed as described above), then the set of point roles is reduced to the point roles of the corresponding template. In this regard, in some embodiments, the matching of point roles is a two-stage process. First, if there are confirmed mapping structures amongst the mapping structures for a property, then the confirmed mapping structures may be applied to reduce the number of point role candidates. Thus, given a confirmed mapping structure, all point roles are eliminated from the candidate list that have a different concept term for the particular concept type defined. Point roles, however, which do not specify that particular concept type, remain on the candidate list since point role definitions may not specify all concept types and may leave some of them open. For example, an example mapping includes:

$$[ RTU 3 RaFanEn -> ReturnAir ( DistributionLocation ) , 1. ] .$$

Given the confidence value of 1.0 (e.g., a confirmed mapping structure), all point roles can be sorted out or eliminated for the property that has a different concept term than “ReturnAir” to specify the DistributionLocation. However, all point roles that do not specify the DistributionLocation remain in the candidate list.

Each of the remaining point roles in the candidate list are then matched to mapping structures for the respective property. In this regard, for each point role, the intersection of its concept terms with the concept terms given by the set of mapping structures is determined. The confidence values of the mapping structure for the concept term in this intersecting set are taken and used to calculate the confidence of the point role match. For example, the confidence value of the point role match may be determined using the formula:

$$pointroleMatchConfidence = Σ confidenceValue n$$

$$Mm = 1 no 0 fConceptTermsInPointrole$$

With M being the number of concept terms in the intersecting set and thus, the confidence values and pointRoleMatchConfidence take values in the interval (0, 1).

In this regard, turning to method 900 of FIG. 9A, at operation 901, the context discovery system 105, such as the reasoning circuitry 114, processor 202, and/or the like, is configured to determine, for a respective data point and a respective point role template of a point role template set, a point role match confidence value based at least on an identification of a concept term associated with both a mapping structure associated with the respective data point and the respective point role template.

After the point role calculations, a prioritized list of the most likely or best matching point roles is derived for each property by ordering the matching point roles according to their pointRoleMatchConfidence values. In this regard, the context discovery system 105, such as the reasoning circuitry 114, processor 202, and/or the like, may be configured to generate a ranked listing of the point role match confidence values, with the point role mapping structure being generated based on having the highest point role match confidence value of the ranked listing of the determined point role match confidence values. At operation 903, the context discovery system 105, such as the reasoning circuitry 114, processor 202, and/or the like, is configured to generate, based at least on the point role match confidence value, a point role mapping structure comprising at least an indication of the respective data point and an indication of the respective point role template.

Turning back to FIG. 3, at operation 305, the context discovery system 105, such as the context generation circuitry 115, processor 202, and/or the like, is configured to generate context data, based on the processing of the output data, for the asset system comprising the one or more definitive mappings of respective data points.

The generated context data comprises the one or more definitive mappings resulting from merged mapping structures exceeding a predefined confidence threshold as described above in connection with FIG. 7. Additionally, the generated context data may also comprise other mapping structures determined by the context discovery operations (e.g., unmapped data points not definitively mapped to a conceptual entity) and associated confidence values, including the mapping structures failing to exceed the predefined confidence threshold. Additionally, in some embodiments, the generated context data can comprise indications of the determined asset types for one or more assets as described above in connection with FIG. 8. Additionally, in some embodiments, the generated context data can comprise the one or more point role mapping structures as described above in connection with FIG. 9.

In some embodiments, the context discovery system 105, such as the context generation circuitry 115, communications circuitry 208, processor 202, and/or the like is configured to cause transmission of the generated context data to a semantic model generation application. For example, the semantic model generation application comprises a software application running on an associated computing device 102 supporting the generation of a digital model for an asset system. In this regard, the generation of context data by the context discovery system 105 provides an accurate and efficient means for the digital model of an asset system to be generated, as all or a majority of the asset system may be accurately represented by the generated context data. Thus an onboarding time of assets for the digital model is reduced, allowing for quicker generation of digital models and subsequent analytical operations to be performed for asset systems.

In some example embodiments, certain ones of the operations herein can be modified or further amplified as described below. Moreover, in some embodiments additional optional operations can also be included. It should be appreciated that each of the modifications, optional additions or amplifications described herein can be included with the operations herein either alone or in combination with any others among the features described herein.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments can be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The hardware used to implement the various illustrative logics, logical blocks, modules, and circuits described in connection with the aspects disclosed herein can include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor can be a microprocessor, but, in the alternative, the processor can be any processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Alternatively, or in addition, some steps or methods can be performed by circuitry that is specific to a given function.

In one or more example embodiments, the functions described herein can be implemented by special-purpose hardware or a combination of hardware programmed by firmware or other software. In implementations relying on firmware or other software, the functions can be performed as a result of execution of one or more instructions stored on one or more non-transitory computer-readable media and/or one or more non-transitory processor-readable media. These instructions can be embodied by one or more processor-executable software modules that reside on the one or more non-transitory computer-readable or processor-readable storage media. Non-transitory computer-readable or processor-readable storage media can in this regard comprise any storage media that can be accessed by a computer or a processor. By way of example but not limitation, such non-transitory computer-readable or processor-readable media can include random access memory (RAM), read-only memory (ROM), electrically erasable programmable read-only memory (EEPROM), FLASH memory, disk storage, magnetic storage devices, or the like. Disk storage, as used herein, includes compact disc (CD), laser disc, optical disc, digital versatile disc (DVD), floppy disk, and Blu-ray Disc™, or other storage devices that store data magnetically or optically with lasers. Combinations of the above types of media are also included within the scope of the terms non-transitory computer-readable and processor-readable media. Additionally, any combination of instructions stored on the one or more non-transitory processor-readable or computer-readable media can be referred to herein as a computer program product.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the supply management system. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

What is claimed is:

1. A method comprising:
receiving telemetry data comprising a plurality of data points associated with an asset system;
processing the telemetry data in accordance with one or more context discovery operations;
determining, based on the processing of the telemetry data, for each context discovery operation, output data comprising one or more mapping structures indicative of a potential mapping for a respective data point of the plurality of data points;
processing the output data, the processing identifying one or more definitive mappings; and
generating context data, based on the processing of the output data, for the asset system comprising the one or more definitive mappings of respective data points.

2. The method of claim 1, each data point of the plurality of data points comprising one or more of text data, time-series data, and hierarchical data.

3. The method of claim 1, each mapping structure comprising a confidence value indicative of a confidence of the potential mapping.

4. The method of claim 1, the processing of the output data comprising merging at least a portion of the one or more mapping structures.

5. The method of claim 4, the context data further comprising at least one mapping structure of the one or more mapping structures indicative of the potential mapping for the respective data point of the plurality of data points, the at least one mapping structure associated with a portion of the mapping structures not having undergone the merging.

6. The method of claim 1, further comprising:
determining whether a confidence value associated with a merger of two or more mapping structures exceeds a predefined confidence threshold; and
in accordance with the determination that the confidence value exceeds the predefined confidence threshold:
identifying the merger of the two or more mapping structures as a definitive mapping.

7. The method of claim 1, the processing of the telemetry data in accordance with the one or more context discovery operations comprising processing the telemetry data in accordance with one or more token interpretation operations, one or more context translation operations, and one or more statistical classification operations.

8. The method of claim 7, the processing of the telemetry data in accordance with the one or more token interpretation operations comprising:
identifying one or more tokens of text data associated with a respective data point of the plurality of data points;
determining a mapping structure of at least one token of the one or more tokens to a predefined token of a predefined token set based on at least a portion of the at least one token matching the predefined token; and
determining a confidence value for the mapping structure based at least on a character length of the portion of the at least one token and a character length of the predefined token.

9. The method of claim 1, the processing of the output data comprising processing the output data in accordance with a point role template set to generate one or more point role mapping structures, the processing comprising:
determining, for a respective data point and a respective point role template of a point role template set, a point role match confidence value based at least on an identification of a concept term associated with both a mapping structure associated with the respective data point and the respective point role template; and
based at least on the point role match confidence value, generate a point role mapping structure comprising at least an indication of the respective data point and an indication of the respective point role template,
the context data further comprising the one or more point role mapping structures.

10. The method of claim 1, further comprising:
causing transmission of the generated context data to a semantic model generation application.
